(19) United States
(12) Patent Application Publication
(10) Pub. No.: US 2014/0095155 A1
(43) Pub. Date: Apr. 3, 2014

(54) METHOD AND APPARATUS FOR CONTROLLING SPEECH QUALITY AND LOUDNESS

(71) Applicant: HUAWEI DEVICE CO., LTD., Shenzhen (CN)

(72) Inventor: Yanhui REN, Beijing (CN)

(73) Assignee: HUAWEI DEVICE CO., LTD., Shenzhen (CN)

(21) Appl. No.: 14/039,538

(22) Filed: Sep. 27, 2013

(30) Foreign Application Priority Data
Sep. 28, 2012 (CN) 201210370356.5

(51) Int. Cl. G10L 21/003

(52) U.S. Cl. CPC G10L 21/003
USPC 704/225

(57) ABSTRACT

A method and an apparatus for controlling speech quality and loudness are disclosed in the present invention, which belong to the field of communications technologies. The method includes: when a terminal starts hands-free calling, obtaining information of a scenario where the terminal is located; obtaining a speech quality preset value and a loudness gain value of the terminal based on the scenario information; and adjusting speech quality and loudness of the terminal respectively based on the obtained speech quality preset value and the loudness gain value. In the present invention, through obtaining a speech quality preset value and a loudness gain value based on scenario information to control speech quality and loudness of a terminal, a user can enjoy better speech quality, thereby improving user experience of hands-free calling.

### CROSS-REFERENCE TO RELATED APPLICATIONS

This application claims priority to Chinese Patent Application No. 201210370356.5, filed on Sep. 28, 2012, which is hereby incorporated by reference in its entirety.

### TECHNICAL FIELD

The present invention relates to the field of communications technologies, and in particular, to a method and an apparatus for controlling speech quality and loudness.

### BACKGROUND

In the times with widespread conference phones and handheld devices, a requirement for call performance of a phone, a pad or other small devices is increasing. In particular, many users nowadays need to use hands-free calling for convenience or in some special scenarios, thereby increasing the requirement for hands-free calling quality. However, when using hands-free calling, the noise in a scenario where a user is located greatly impacts the quality of hands-free calling, so that how to guarantee speech quality and loudness during hands-free calling asks for a solution.

The prior art provides an automatic volume control technique for controlling the volume of hands-free calling. In this method, corresponding volume for answering voice to ensure that the user hears the caller with the present noise level is automatically set according to the noise level of the environment.

However, in the automatic volume control technique in the prior art, only the volume of voice is increased to ensure user experience of volume. Nevertheless, the volume is just a part of the voice, and it is necessary to further enhance the quality of the voice so as to improve the user experience of hands-free calling.

### SUMMARY

To improve user experience of hands-free calling, embodiments of the present invention provide a method and an apparatus for controlling speech quality and loudness. The technical solutions are as follows:

In a first aspect, a method for controlling speech quality and loudness is provided, where the method includes: when a terminal starts hands-free calling, obtaining information of a scenario where the terminal is located; obtaining a speech quality preset value and a loudness gain value of the terminal based on the scenario information; and adjusting speech quality and loudness of the terminal respectively based on the obtained speech quality preset value and the loudness gain value.

In a first possible implementation manner of the first aspect, the obtaining information of a scenario where the terminal is located includes:

starting a camera of the terminal so as to shoot information of the scenario where a user using the terminal is located.

In a second possible implementation manner of the first aspect, the obtaining information of a scenario where the terminal is located includes:

starting an infrared sensor of the terminal to obtain information of the scenario where a user using the terminal is located based on temperature information obtained by the infrared sensor.

In combination with the first aspect, or the first possible implementation manner of the first aspect, or the second possible implementation manner of the first aspect, in a third possible implementation manner of the first aspect, the obtaining a speech quality preset value and a loudness gain value of the terminal based on the scenario information includes:

locally searching for a speech quality preset value and a loudness gain value that match the scenario information; or

uploading the scenario information to a network side so as to enable the network side to search for a speech quality preset value and a loudness gain value that match the scenario information; and

receiving the speech quality preset value and the loudness gain value that match the scenario information and are returned by the network side.

In a second aspect, an apparatus for controlling speech quality and loudness is provided, where the apparatus includes:

a first obtaining module, configured to obtain, when a terminal starts hands-free calling, information of a scenario where the terminal is located;

a second obtaining module, configured to obtain a speech quality preset value and a loudness gain value of the terminal based on the scenario information; and

an adjusting module, configured to adjust speech quality and loudness of the terminal respectively based on the obtained speech quality preset value and the loudness gain value.

In a first possible implementation manner of the second aspect, the first obtaining module includes:

a first starting unit, configured to start a camera of the terminal so as to shoot information of the scenario where a user using the terminal is located.

In a second possible implementation manner of the second aspect, the first obtaining module includes:

a second starting unit, configured to start an infrared sensor of the terminal to obtain information of the scenario where a user using the terminal is located based on temperature information obtained by the infrared sensor.

In combination with the second aspect, or the first possible implementation manner of the second aspect, or the second possible implementation manner of the second aspect, in a third possible implementation manner of the first aspect, the second obtaining module includes:

a searching unit, configured to locally search for a speech quality preset value and a loudness gain value that match the scenario information; or

an uploading unit, configured to upload the scenario information to a network side so as to enable the network side to search for a speech quality preset value and a loudness gain value that match the scenario information; and

a receiving unit, configured to receive the speech quality preset value and the loudness gain value that match the scenario information and are returned by the network side.

Technical solutions according to the embodiments of the present invention have the following beneficial effects: speech quality and loudness of a terminal are under control and a user can enjoy better speech quality, thereby improving user experience of a hands-free terminal, through, when a terminal starts hands-free calling, obtaining information of a scenario where the terminal is located; obtaining a speech quality preset value and a loudness gain value of the terminal based on the scenario information; and adjusting speech quality and loudness of the terminal respectively based on the obtained speech quality preset value and the loudness gain value.

### BRIEF DESCRIPTION OF DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a flowchart of a method for controlling speech quality and loudness according to an embodiment of the present invention;

FIG. 2 is a flowchart of a method for controlling speech quality and loudness according to an embodiment of the present invention;

FIG. 3 is a structural schematic diagram of an apparatus for controlling speech quality and loudness according to an embodiment of the present invention;

FIG. 4 is a structural schematic diagram of another apparatus for controlling speech quality and loudness according to an embodiment of the present invention; and

FIG. 5 is schematic diagram of a terminal according to an embodiment of the present invention.

### DESCRIPTION OF EMBODIMENTS

To make the objectives, technical solutions, and advantages of the embodiments of the present invention more clearly, the following further describes the embodiments of the present invention in detail with reference to the accompanying drawings.

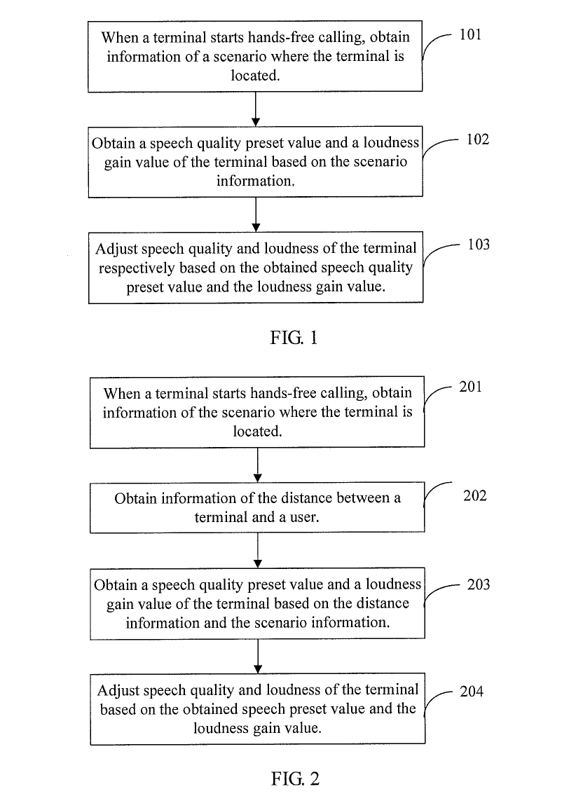

Referring to FIG. 1, this embodiment provides a method for controlling speech quality and loudness, including:

Step 101: When a terminal starts hands-free calling, obtain information of a scenario where the terminal is located;

Step 102: Obtain a speech quality preset value and a loudness gain value of the terminal based on the scenario information; and

Step 103: Adjust speech quality and loudness of the terminal respectively based on the obtained speech quality preset value and the loudness gain value.

Optionally, the obtaining information of a scenario where the terminal is located includes:

starting a camera of the terminal so as to shoot information of the scenario where a user using the terminal is located.

Optionally, the obtaining information of a scenario where the terminal is located includes:

starting an infrared sensor of the terminal to obtain information of the scenario where a user using the terminal is located based on temperature information obtained by the infrared sensor.

Optionally, the obtaining a speech quality preset value and a loudness gain value of the terminal based on the scenario information includes:

locally searching for a speech quality preset value and a loudness gain value that match the scenario information; or

uploading the scenario information to a network side so as to enable the network side to search for a speech quality preset value and a loudness gain value that match the scenario information; and

receiving the speech quality preset value and the loudness gain value that match the scenario information and are returned by the network side.

In this embodiment, a speech quality preset value and a loudness gain value of the terminal include: a speech quality preset value and a loudness gain value of a speaker and a speech quality preset value and a loudness gain value of a microphone.

This embodiment has the following beneficial effects: speech quality and loudness of a terminal are under control and a user can enjoy better speech quality, thereby improving user experience of a hands-free terminal, through, when a terminal starts hands-free calling, obtaining information of a scenario where the terminal is located; obtaining a speech quality preset value and a loudness gain value of the terminal based on the scenario information; and adjusting speech quality and loudness of the terminal respectively based on the obtained speech quality preset value and the loudness gain value.

An embodiment of the present invention provides a method for controlling speech quality and loudness. The speech quality and the loudness during a call may be automatically adjusted based on a comprehensive evaluation on information, such as a using habit, an application scenario, and a distance between the human body and a device concerning a user using a phone, a pad or other handheld devices. As shown in FIG. 2, the method procedure includes:

Step 201: When a terminal starts hands-free calling, obtain information of a scenario where the terminal is located.

In this embodiment, a terminal includes a phone, a pad or devices that may realize hands-free calling, which is not specifically limited herein. In this embodiment, the hands-free calling includes video calls and audio calls, which is not specifically limited herein.

When a terminal starts hands-free calling, the noise in the scenario where the terminal is located may cause certain interference in speech quality. In addition, when a user is located in different scenarios, the terminal requires different gains. For example, in a quiet environment or a noisy subway station, a terminal requires different gains. Therefore, in this embodiment, the environment where a user is located is taken as a condition for adjusting terminal gains. The obtaining information of a scenario where the terminal is located specifically includes: starting a camera of the terminal so as to shoot information of the scenario where a user using the terminal is located. In this embodiment, after the camera shoots the scenario where a user using the terminal is located such as decorations, sounds and objects set in the scene, the shot pictures or sounds are compared with data stored in a database so as to obtain the information of the scenario where the user is located.

In this embodiment, when a terminal is provided with an infrared function, optionally, the obtaining information of a scenario where the terminal is located includes: starting an infrared sensor of the terminal to obtain information of the scenario where a user using the terminal is located based on temperature information obtained by the infrared sensor. In this embodiment, the technique of obtaining scenario information through infrared ray is similar to the prior art, and is not described herein.

Step 202: Obtain information of the distance between a terminal and a user.

In this embodiment, when a user starts the hands-free calling function of a terminal, to improve speech quality of the terminal and realize that speech quality can be adjusted in compliance with the distance between the user and the terminal, or in other words, when a user moves, to ensure that the quality of heard sounds may be free from the influence of the changing distance from the user. In this embodiment, the distance between the terminal and the user may further be taken as a condition for adjusting speech quality gains, where there are many methods for obtaining the information of the distance between a terminal and a user, which include but not are not limited to using a camera or an infrared sensor on the terminal to obtain the information of the distance between the terminal and the user.

In this embodiment, a method for obtaining the information of the distance between a terminal and a user by using a camera includes: starting the camera on the terminal and focusing the camera at the user who uses the terminal; obtaining the information of the position where the camera of the terminal focuses at; and calculating the distance information between the terminal and the user based on the position information. When a user starts hands-free calling, the terminal automatically starts the camera and focuses the camera at the user to obtain image information of the user, and calculates the distance between the user and the terminal based on the position where the camera focuses at, where the specific calculation method is similar to the prior art and is not described herein.

In this embodiment, optionally, if a terminal is provided with an infrared sensor, it is still possible to obtain the information of the distance between the user and the terminal by using the infrared sensor, where the method specifically includes: starting the infrared sensor on the terminal to scan the user who uses the terminal; calculating the time of feeding back after the infrared sensor scans the user through the infrared ray; and calculating the distance information between the terminal and the user based on the feeding back time. When a user starts hands-free calling, the terminal automatically starts an infrared sensor and scan the user through the infrared ray, calculates the time of feeding back after the infrared ray scans the user, and calculates the distance between the user and the terminal based on the feeding back time, where the specific calculation method is similar to the prior art and is not described herein.

It should be noted that step 202 in this embodiment is optional and may be skipped during a practical procedure, which is not specifically limited herein.

Step 203: Obtain a speech quality preset value and a loudness gain value of the terminal based on the distance information and the scenario information.

In this embodiment, a database is established beforehand The database is used to store a speech quality preset value and a loudness gain value that correspond to scenario information. Naturally, the database may further include a speech quality preset value and a loudness gain value that correspond to scenario information and to the distance between a user and a terminal. A speech quality preset value, including the preset values of parameters such as frequency responses, echoes and audio denoising, is used to adjust the speech quality that a MIC sends and the speech quality that a speaker receives; a loudness gain value is used to adjust the loudness that the microphone sends and the loudness that the speaker receives. In a specific implementation process, the database may be stored on the terminal or on the network side, which is not specifically limited in this embodiment.

Optionally, when the database is stored on the terminal, the obtaining a speech quality preset value and a loudness gain value of the terminal based on the scenario information includes: locally searching for a speech quality preset value and a loudness gain value that match the scenario information.

Optionally, when the database is stored on the network side, the obtaining a speech quality preset value and a loudness gain value of the terminal based on the scenario information includes: uploading the scenario information to the network side so as to enable the network side to search for a speech quality preset value and a loudness gain value that match the scenario information; and receiving the speech quality preset value and the loudness gain value that match the scenario information and are returned by the network side.

In this embodiment, if step 202 is performed, specifically, the information of the distance between a user and a terminal and the scenario information where the terminal is located are used as two conditions for obtaining a speech quality preset value and a loudness gain value. The specific obtaining method is, similar to the method of the obtaining a speech quality preset value and a loudness gain value based on the scenario information, locally searching for a speech quality preset value and a loudness gain value that correspond to the distance information and the scenario information in a database, or obtaining a speech quality preset value and a loudness gain value that correspond to the distance information and the scenario information from the network side. This embodiment does not specifically limit the method to obtain a speech quality preset value and a loudness gain value that correspond to the distance information and the scenario information.

In this embodiment, to improve speech quality received by both parties involved in a call, not only the gain of a speaker (speaker) of a terminal is adjusted, but also the gain of a microphone may further be adjusted. Therefore, in this embodiment, a speech quality preset value and a loudness gain value include: a speech quality preset value and a loudness gain value of a speaker and a speech quality preset value and a loudness gain value of a microphone. Certainly, a gain value of a microphone may not be adjusted, which is not specifically limited in this embodiment.

In this embodiment, gains are different when the scenario where a user is located and the distance between a user and a terminal are different. A terminal automatically adjusts the output of speech quality and loudness according to different scenarios such as a bedroom, or an office, or a subway so as to achieve the optimal speech quality, so that a user may enjoy better experience when using hands-free calling.

Step 204: Adjust speech quality and loudness of the terminal respectively based on the obtained speech quality preset value and the loudness gain value.

In this embodiment, a speech quality preset value and a loudness gain value of the terminal are obtained based on the information of the scenario where a user is located and of the distance between a user and a terminal, and speech quality and loudness of a speaker or a microphone are adjusted based on the obtained speech quality preset value and the loudness gain value, so that a terminal provides the optimal speech quality. Specifically, the adjusting speech quality of the terminal based on the obtained speech quality preset value includes: increasing or decreasing parameters such as frequency responses, echoes, audio responses and echoes, and audio denoising based on the speech quality preset value. The adjusting loudness of the terminal based on the obtained loudness gain value includes: turning up or turning down loudness according to the gain value.

The method for adjusting speech quality and loudness of a speaker or a microphone based on the speech quality preset value and the loudness gain value is similar to the prior art, which is not described herein.

This embodiment has the following beneficial effects: speech quality and loudness of a terminal are under control and a user can enjoy better speech quality, thereby improving user experience of a hands-free terminal, through, when a terminal starts hands-free calling, obtaining information of a scenario where the terminal is located; obtaining a speech quality preset value and a loudness gain value of the terminal based on the scenario information; and adjusting speech quality and loudness of the terminal respectively based on the obtained speech quality preset value and the loudness gain value.

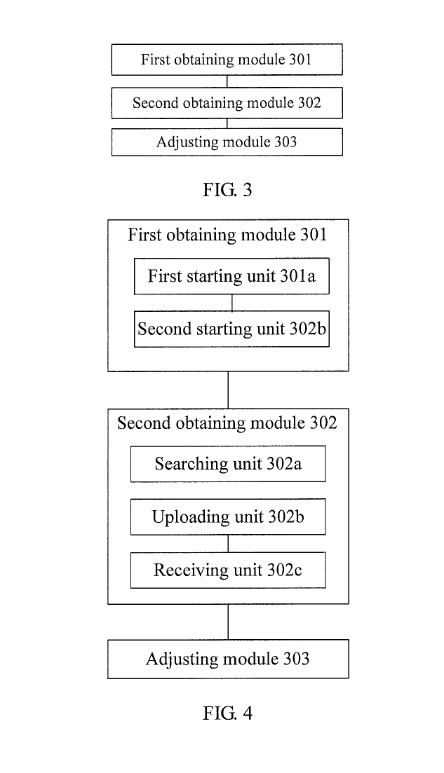

Referring to FIG. 3, an embodiment of the present invention provides an apparatus for controlling speech quality and loudness, including: a first obtaining module 301, a second obtaining module 302, and an adjusting module 303.

The first obtaining module 301 is configured to obtain, when a terminal starts hands-free calling, information of a scenario where the terminal is located.

The second obtaining module 302 is configured to obtain a speech quality preset value and a loudness gain value of the terminal based on the scenario information.

The adjusting module 303 is configured to adjust speech quality and loudness of the terminal respectively based on the obtained speech quality preset value and the loudness gain value.

Optionally, referring to FIG. 4, the first obtaining module 301 includes:

a first starting unit 301a, configured to start a camera of the terminal so as to shoot information of the scenario where a user using the terminal is located.

Optionally, referring to FIG. 4, the first obtaining module 301 includes:

a second starting unit 301b, configured to start an infrared sensor of the terminal to obtain information of the scenario where a user using the terminal is located based on temperature information obtained by the infrared sensor.

Optionally, the second obtaining module 302 includes:

a searching unit 302a, configured to locally search for speech quality and a loudness gain value that match the scenario information; or

an uploading unit 302b, configured to upload the scenario information to a network side so as to enable the network side to search for a speech quality preset value and a loudness gain value that match the scenario information; and

a receiving unit 302c, configured to receive the speech quality preset value and the loudness gain value that match the scenario information and are returned by the network side.

In this embodiment, a speech quality preset value and a loudness gain value of the terminal include: a speech quality preset value and a loudness gain value of a speaker and a speech quality preset value and a loudness gain value of a microphone.

This embodiment has the following beneficial effects: speech quality and loudness of a terminal are under control and a user can enjoy better speech quality, thereby improving user experience of a hands-free terminal, through, when a terminal starts hands-free calling, obtaining information of a scenario where the terminal is located; obtaining a speech quality preset value and a loudness gain value of the terminal based on the scenario information; and adjusting speech quality and loudness of the terminal respectively based on the obtained speech quality preset value and the loudness gain value.

It should be noted that, the embodiment which provides an apparatus for controlling speech quality and loudness only use division of the functional modules for description. In practice, the functions may be assigned to different functional modules for implementation as required. To be specific, the internal structure of the apparatus is divided into different functional modules to implement all or part of the above-described functions.

In addition, the apparatus for controlling speech quality and loudness as well as the method for controlling speech quality and loudness provided in the embodiments belong to the same conception. For the details of the specific implementation process, refer to the method embodiments. The specific implementation process is not described herein.

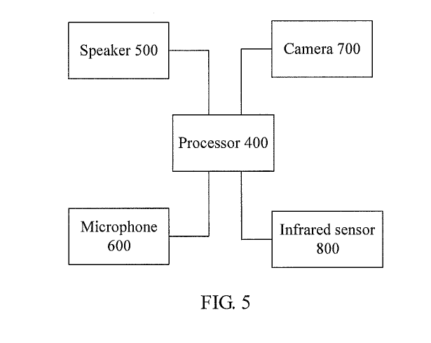

Referring to FIG. 5, this embodiment provides a terminal, including: a processor 400;

The processor 400 is configured to obtain, when a terminal starts hands-free calling, information of a scenario where the terminal is located; obtain a speech quality preset value and a loudness gain value of the terminal based on the scenario information; and adjust speech quality and loudness of the terminal respectively based on the obtained speech quality preset value and the loudness gain value.

Referring FIG. 5, the terminal includes: a speaker 500 and a microphone 600. Optionally, the terminal further includes: a camera 700 and/or an infrared sensor 800.

Optionally, the obtaining information of a scenario where the terminal is located includes:

starting a camera of the terminal so as to shoot information of the scenario where a user using the terminal is located; or

starting an infrared sensor of the terminal to obtain information of the scenario where a user using the terminal is located based on temperature information obtained by the infrared sensor.

Optionally, the obtaining a speech quality preset value and a loudness gain value of the terminal based on the scenario information includes:

locally searching for a speech quality preset value and a loudness gain value that match the scenario information; or

uploading the scenario information to a network side so as to enable the network side to search for a speech quality preset value and a loudness gain value that match the scenario information; and

receiving the speech quality preset value and the loudness gain value that match the scenario information and are returned by the network side.

In this embodiment, a speech quality preset value and a loudness gain value of the terminal include: a speech quality preset value and a loudness gain value of the speaker 500 and a speech quality preset value and a loudness gain value of the microphone 600.

This embodiment has the following beneficial effects: speech quality and loudness of a terminal are under control and a user can enjoy better speech quality, thereby improving user experience of a hands-free terminal, through, when a terminal starts hands-free calling, obtaining information of a scenario where the terminal is located; obtaining a speech quality preset value and a loudness gain value of the terminal based on the scenario information; and adjusting speech quality and loudness of the terminal respectively based on the obtained speech quality preset value and the loudness gain value.

The sequence numbers of the preceding embodiments of the present invention are merely for description purpose but do not indicate the preference of the embodiments.

Persons of ordinary skill in the art should understand that all or a part of the steps of the method in the embodiments may be implemented by hardware or a program instructing relevant hardware. The program may be stored in a computer readable storage medium. The storage medium may include a read-only memory, a magnetic disk, and an optical disk.

The foregoing descriptions are merely exemplary embodiments of the present invention, but are not intended to limit the present invention. Any modification, equivalent replacement, or improvement derived within the spirit and principle of the present invention shall fall within the protection scope of the present invention.

What is claimed is:

1. A method for controlling speech quality and loudness, comprising:
obtaining, when a terminal starts hands-free calling, information of a scenario where the terminal is located;
obtaining a speech quality preset value and a loudness gain value of the terminal based on the scenario information; and
adjusting speech quality and loudness of the terminal respectively based on the obtained speech quality preset value and the loudness gain value.

2. The method according to claim 1, wherein the obtaining information of a scenario where the terminal is located comprises:
starting a camera of the terminal so as to shoot information of the scenario where a user using the terminal is located.

3. The method according to claim 1, wherein the obtaining information of a scenario where the terminal is located comprises:
starting an infrared sensor of the terminal to obtain information of the scenario where a user using the terminal is located based on temperature information obtained by the infrared sensor.

4. The method according to claim 1, wherein the obtaining a speech quality preset value and a loudness gain value of the terminal based on the scenario information comprises:
locally searching for a speech quality preset value and a loudness gain value that match the scenario information; or
uploading the scenario information to a network side so as to enable the network side to search for a speech quality preset value and a loudness gain value that match the scenario information; and
receiving the speech quality preset value and the loudness gain value that match the scenario information and are returned by the network side.

5. The method according to claim 1, wherein a speech quality preset value and a loudness gain value of the terminal comprise: a speech quality preset value and a loudness gain value of a speaker and a speech quality preset value and a loudness gain value of a microphone.

6. An apparatus for controlling speech quality and loudness, comprising:
a first obtaining module, configured to obtain, when a terminal starts hands-free calling, information of a scenario where the terminal is located;
a second obtaining module, configured to obtain a speech quality preset value and a loudness gain value of the terminal based on the scenario information; and
an adjusting module, configured to adjust speech quality and loudness of the terminal respectively based on the obtained speech quality preset value and the loudness gain value.

7. The apparatus according to claim 6, wherein the first obtaining module comprises:
a first starting unit, configured to start a camera of the terminal so as to shoot information of the scenario where a user using the terminal is located.

8. The apparatus according to claim 6, wherein the first obtaining module comprises:
a second starting unit, configured to start an infrared sensor of the terminal to obtain information of the scenario where a user using the terminal is located based on temperature information obtained by the infrared sensor.

9. The apparatus according to claim 6, wherein the second obtaining module comprises:
a searching unit, configured to locally search for a speech quality preset value and a loudness gain value that match the scenario information; or
an uploading unit, configured to upload the scenario information to a network side so as to enable the network side to search for a speech quality preset value and a loudness gain value that match the scenario information; and
a receiving unit, configured to receive the speech quality preset value and the loudness gain value that match the scenario information and are returned by the network side.

10. The apparatus according to claim 6, wherein a speech quality preset value and a loudness gain value of the terminal comprise: a speech quality preset value and a loudness gain value of a speaker and a speech quality preset value and a loudness gain value of a microphone.
